(19) United States
(12) Patent Application Publication
(10) Pub. No.: US 2008/0271220 A1
(43) Pub. Date: Nov. 6, 2008

(54) Wearable Electronic Device

(76) Inventors: Nissim Chilton, Irvine (GB); Bill Miller, Irvine (GB)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 11/914,826

(22) PCT Filed: May 19, 2006
(86) PCT No.: PCT/GB2006/001840

§ 371 Date: Mar. 31, 2008

(30) Foreign Application Priority Data
May 20, 2005 (GB) 0510312.2

(51) Int. Cl. A41D 13/00; H04R 1/02

(52) U.S. Cl. 2/69; 381/333; 29/428

(57) ABSTRACT

A wearable electronic device (18) is sealed within a waterproof casing (20) and located within a sealable pocket (16) of a garment (10). The electronic device (18) comprises a power supply (24), a programmable device (26), an output device (28) adapted to be controlled by the programmable device (26), and an input device (32) adapted to be activated to operate the output device (28) via the programmable device (26). In one disclosed embodiment the input device (32) comprises a switch and the output device (28) comprises a speaker adapted to play sound stored on the electronic device (18).

### FIELD OF THE INVENTION

The present invention relates to a garment, and in particular to a garment incorporating an electronic device. The present invention also relates to a wearable device which is adapted to be secured to an item of clothing, and in particular, but not exclusively, to a wearable audio player.

### BACKGROUND TO THE INVENTION

Numerous novelty-type items of clothing exist, such as neckties, which incorporate very basic buzzer-type speakers adapted to play synthesised sound. However, the quality and functionality of such novelty items is restricted due to the requirement to utilise electrical components which are very inexpensive. Furthermore, it is often the case that such novelty items cannot be laundered in a conventional manner without causing damage to the electronic components.

It is among the objects of embodiments of the present invention to provide a garment which incorporates a functional electrical device which may be operated by a user wearing the garment.

### SUMMARY OF THE INVENTION

According to a first aspect of the present invention, there is provided a garment comprising a sealable pocket and an electronic device sealed within a waterproof casing and located within said sealable pocket, said electronic device comprising a power supply, a programmable device, an output device adapted to be controlled by the programmable device, and an input device adapted to be activated to operate the output device via the programmable device.

Advantageously, in use, a user may operate the electronic device located within the pocket by activating the input device externally of the pocket, for example by pressing on an area of the garment incorporating the device, in order to achieve the desired output from the output device. In this way, the electronic device may remain sealed within the pocket.

References herein to garments primarily relate to items of clothing, including outer wear, inner wear, sleepwear, headgear, scarves, footwear and the like, but additionally relate to other items such as bedding, baggage and other personal items.

Some or all of the components of the electronic device may be separately formed, or alternatively some or all of the components may be integrally formed.

The electronic device may comprise a printed circuit board upon which at least one of the programmable device, power supply, output device and input device is mounted. Alternatively, or additionally, some or all of the components of the electronic device may be mounted on a flexible substrate. In one aspect of the invention features of the electronic device may be directly mounted on the garment, or alternatively may be incorporated into the garment. For example, electronic circuitry may be woven or otherwise formed within the garment.

The programmable device may comprise an integrated circuit and may form a microprocessor or the like.

The input device may comprise at least one switch, such as a push-button switch, rocker switch, pressure switch or the like. Alternatively, or in addition, the input device may comprise at least one receiver adapted to receive an input signal. The receiver may be an infrared, radio frequency, microwave receiver, or alternatively a sound receiver such as a microphone or the like. Advantageously, upon receiving an appropriate input signal, the receiver may operate the output device via the programmable device. The output device may be operated to provide one or more of a variety of outputs, depending on, for example, the nature, source or timing of the input signal.

Preferably, the electronic device further comprises a memory device. The memory device may incorporate a flash ROM memory device, masked ROM memory device, programmable ROM memory device or the like. The memory device may advantageously be adapted to store audio files, such as music files or the like, or any other data, such as software, for example.

The memory device may form part of the programmable device. Alternatively, the memory device may be separately formed from the programmable device. This arrangement advantageously permits the memory device to be readily programmed and reprogrammed to store data independently of the installation and/or operation of the programmable device. In embodiments where the memory device is separately formed from the programmable device, the memory device advantageously incorporates a flash ROM memory device.

Advantageously, the memory device may be adapted to receive data via a suitable memory input. The memory input may comprise a hard wire connection. Alternatively, the memory device may comprise a wireless receiver device adapted to wirelessly receive data to be stored. This arrangement advantageously permits the electronic device to receive data while remaining sealed within the waterproof casing and also within the pocket. The wireless input receiver may be adapted to receive infrared frequencies, radio frequencies, microwave frequencies or the like. Alternatively, or additionally, the wireless receiver may be adapted to receive sound, for example via a microphone, such that real time audio data may be captured and stored by the memory device.

In embodiments of the present invention, the memory device may be adapted to transmit data via a memory output. The memory output may comprise a hard wire connection, or alternatively may comprise a wireless transmitter, such as an infrared, radio, microwave transmitter or the like.

In one embodiment of the present invention, the output device may comprise a speaker such as a miniature diaphragm speaker, ceramic piezoelectric speaker or the like. In this arrangement, the electronic device may advantageously further comprise an amplifier coupled to the speaker. The amplifier may form part of the programmable device, or alternatively may be provided separately from the programmable device. Alternatively, or additionally, the output device may comprise a light, such as an LED or the like. The output device may alternatively, or additionally, comprise a transmitter, such as an infrared, radio frequency, microwave transmitter or the like, which may permit the electronic device to wirelessly or remotely control or communicate with an external electrical device or appliance, such as another garment, a PDA, visual or audio equipment, mobile telephone or the like. Furthermore, the output device may alternatively, or additionally, comprise a motor or other drive device or actuator.

Preferably, the pocket is adapted to be sealed by stitching. Alternatively, the pocket may be adapted to be sealed via a temporary fastener such as hook and loop fasteners, suitable buttons, zip fasteners or the like.

Preferably, the power source is electrical and comprises at least one battery cell. Advantageously, the battery may be rechargeable. The battery unit may be adapted to be recharged by coupling to an external power source via a wired connection. Alternatively, the battery may be adapted to be recharged by an inductance type charger. Accordingly, the battery unit may be recharged without the requirement to remove the electronic device from the waterproof casing, and also the pocket. The battery cell may alternatively or additionally be adapted to be recharged by a clockwork arrangement.

Preferably, the power source is adapted to be initially insulated from the electronic device. Advantageously, the power source may be adapted to become electrically coupled to the electronic device prior to initial activation thereof. Alternatively, the power source may be adapted to become electrically coupled to the device during initial activation thereof. For example, an insulating barrier may be provided which is adapted to be broken upon initial activation of the input device.

In certain embodiments, the sealable pocket may form the waterproof casing.

Advantageously, by sealing the electronic device in a waterproof casing, the garment may be laundered in a conventional manner, without requiring the electronic device to be removed. The electronic device may be permanently sealed within the waterproof casing. The waterproof casing may be permanently sealed by heat-sealing or welding, such as ultrasonic or RF welding, or the like. Alternatively, the electronic device may be temporarily sealed within the waterproof casing such that said electronic device may be retrieved without destruction of the casing. The waterproof casing may comprise a snap or press fit seal or the like. The waterproof casing may be manufactured, at least partly, from ABS, PVC, TPE, silicone rubber or the like, or from any suitable combination of materials. The casing may be evacuated or filled with a selected fluid or solid material to provide a protective atmosphere for the device. The casing may be of a breathable material, such as expanded PTFE, to, for example, accommodate changes in ambient pressure and temperature, and/or to permit passage of gas therethrough while maintaining a waterproof environment.

The casing may comprise a potting material encapsulating the electronic device such that the potted electronic device may be directly mounted on the garment.

Preferably, the electronic device is sealed within an anti-static membrane. The anti-static membrane may be provided separately and adapted to receive the electronic device, or alternatively the waterproof casing may inherently exhibit anti-static properties such that the waterproof casing also functions as an anti-static membrane.

Preferably, the electronic device is adapted to be programmed by an external device, such as a computer. Advantageously, the electronic device is adapted to be programmed simultaneously with at least one other electronic device such that a plurality of electronic devices may be bulk programmed.

Preferably, the electronic device includes software loaded thereon and the programmable device is adapted to run said software to permit control of the functionality of the electronic device. Preferably, the software permits the programmable device to control the output device in the required manner in accordance with a suitable input signal detected by the input device. For example, the software may control the sequence of playback of an audio file via an output speaker upon depression of an input switch. Preferably also, the software permits control of the power consumption characteristics of the electronic device in order to maximise the life of the power supply. Preferably further, the software permits control of the functional output, which in one embodiment may be an audio output, wherein the software, in conjunction with the programmable device, eliminates or at least minimises distortion of the audio output.

Preferably, the sealable pocket of the garment comprises a fabric, wherein the electronic device is advantageously encased within said fabric. Beneficially, where the electronic device comprises a speaker, the fabric may act as an acoustic filter and improve sound dispersion, improving the overall quality of the sound transmitted from the electronic device through the pocket. Advantageously, the fabric is adapted to filter random frequencies such as hiss and quantisation noise which may exist as a result of digitisation of the sound data to be transmitted.

Advantageously, the sealable pocket may be integrally formed with the garment. Alternatively, the sealable pocket may be separately formed and subsequently secured to the garment. In this arrangement, the pocket may be retrofitted to existing articles of clothing to produce a garment in accordance with the present invention. The pocket may be permanently secured to the garment by, for example, suitable stitching, adhesive bonding, welding, such as ultrasonic or RF welding, or the like. Alternatively, the pocket may be temporarily secured to the garment, for example by hook and loop type fasteners, a zip fastener, clips, buttons, pins or the like. Thus, the pocket may be transferred between different garments.

According to a second aspect of the present invention, there is provided a wearable device adapted to be secured to a garment, said device comprising:

a sealable pocket;

a waterproof casing located within said sealable pocket; and

an electronic device sealed within said waterproof casing, said electronic device comprising a power supply, a programmable device, an output device adapted to be controlled by the programmable device, and an input device adapted to be activated externally of the sealable pocket to operate the output device via the programmable device.

Preferably, the outer sealable pocket comprises a fabric, wherein the electronic device is advantageously encased within said fabric.

Advantageously, the waterproof casing and electronic device may be similar to that described above in accordance with the first aspect.

Beneficially, the functionality of the electronic device may be selected in accordance with user requirements, and subsequently secured to a garment to be worn by a user.

According to a third aspect of the present invention, there is provided a method of manufacturing a garment comprising the steps of securing a wearable device according to the second aspect to a garment.

According to a fourth aspect of the present invention, there is provided a method of manufacturing a garment, said method comprising the steps of:

providing an electronic device having a power supply, a programmable device, an output device adapted to be controlled by the programmable device, and an input device adapted to operate the output device via the programmable device;

sealing said electronic device within a waterproof casing;

locating said electronic device and waterproof casing within a sealable pocket; and

securing said pocket to an article of clothing.

According to a fifth aspect of the present invention, there is provided an audio player comprising:

an outer sealable pocket;

a waterproof casing located within said sealable pocket; and

an electronic circuit sealed within said waterproof casing, said electronic circuit comprising a power supply, a programmable device, a memory device for storing an audio file, a speaker adapted to be controlled by the programmable device, and a switch adapted to be activated externally of the outer sealable pocket.

Preferably, the audio player is adapted to be secured to an article of clothing.

Preferably also, the audio player is washable.

Preferably, the memory device is adapted to store a recorded sound sequence or audio file.

The sound sequence may be of any appropriate length, and may be greater than ten seconds long, preferably more than twenty seconds long, and may be several minutes long. In one embodiment the sound sequence may be around four minutes long.

According to a sixth aspect of the present invention, there is provided a method of incorporating an electronic device in a garment, the method comprising:

programming an electronic device such that the device is capable of producing at least one selected output on activation by a user; and

incorporating the device in a garment,

whereby a user may activate the device in the garment to provide said at least one selected output.

The device may be programmed before or after being incorporated in the garment.

The selected output may be licensed or otherwise controlled, for example a copyrighted song or story.

According to a seventh aspect of the present invention, there is provided a method of doing business, said method comprising the steps of:

obtaining permission to utilise electronically storable data;

providing an electronic device adapted to store and use said data, and programming said electronic device with said data;

securing said electronic device to a garment.

Preferably, the storable data is subject to intellectual property rights, and the method involves the step of obtaining permission from the rights holder. Intellectual property may include, among other things, copyright, data base rights, trade marks, patents for inventions, design rights or the like. Permission from the rights holder may be obtained by, for example, license agreements under the intellectual property rights.

The method may be utilised to provide manufacturers and suppliers of garments, for example, with a means to incorporate the electronic device with the storable data within their garments.

Preferably, the method comprises the step of supplying at least one electronic device incorporating the storable data to a garment manufacturer for incorporation with at least one garment.

### BRIEF DESCRIPTION OF THE DRAWINGS

These and other aspects of the present invention will now be described, by way of example only, with reference to the accompanying drawings in which:

FIG. 1 is a view of a garment, in the form of a t-shirt, incorporating a wearable device in accordance with aspects of the present invention;

FIG. 2 is an enlarged view of a wearable device shown in FIG. 1; and

FIG. 3 is a simplified block diagram of an electronic device which forms part of the wearable device shown in FIGS. 1 and 2.

### DETAILED DESCRIPTION OF THE DRAWINGS

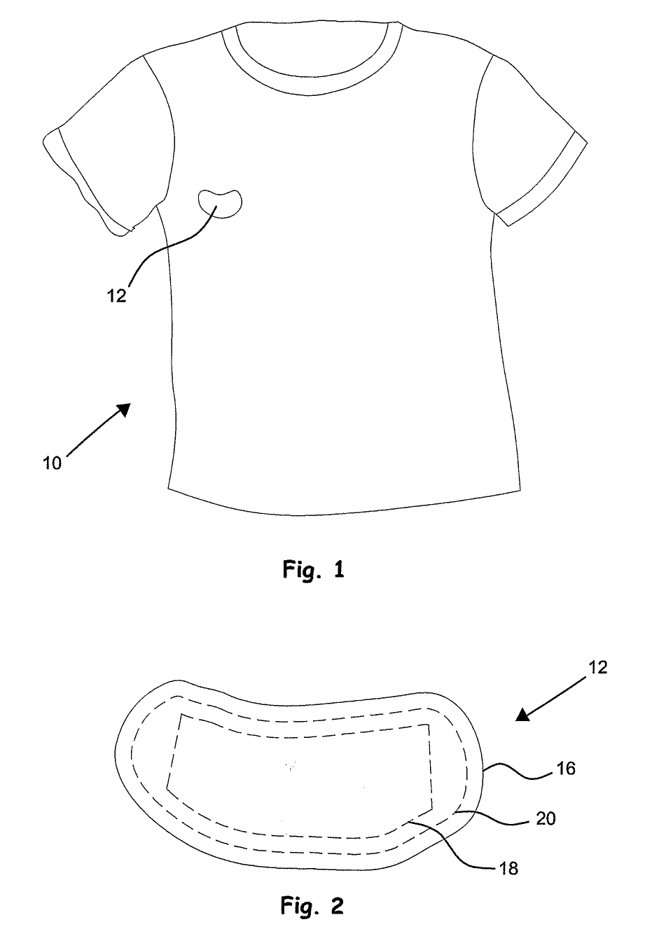

Referring initially to FIG. 1, there is shown a garment, generally represented by reference numeral 10, in accordance with an embodiment of an aspect of the present invention. The garment 10 is a t-shirt and incorporates a wearable device 12 which is secured to the garment 10 and forms an integral part thereof. An enlarged view of the wearable device 12 is shown in FIG. 2, reference to which is now made. The wearable device 12 comprises a fabric outer sealable pocket 16 within which is located an electronic device 18, shown in broken outline, encased and sealed within a waterproof casing 20, also shown in broken outline. The waterproof casing 20 is of a water proof material, such as ABS, PVC, TPE, silicone rubber or the like and is sealed around its outer periphery by heat sealing to provide a water impenetrable barrier. In the embodiment shown, the sealable fabric pocket 16 is sealed by stitching when the electronic device/casing 18, 20 are located therein.

In the embodiment shown, the electronic device 18 is adapted to play a stored music file or files upon depression of a switch (not shown) which is activated through the outer pocket 16 and the waterproof casing 20. The ability to activate the electronic device 18 through the outer pocket 16 and casing 20 advantageously permits playback of audio from the electronic device 18 without requiring the electronic device 18 to be removed from the pocket and casing 16, 20.

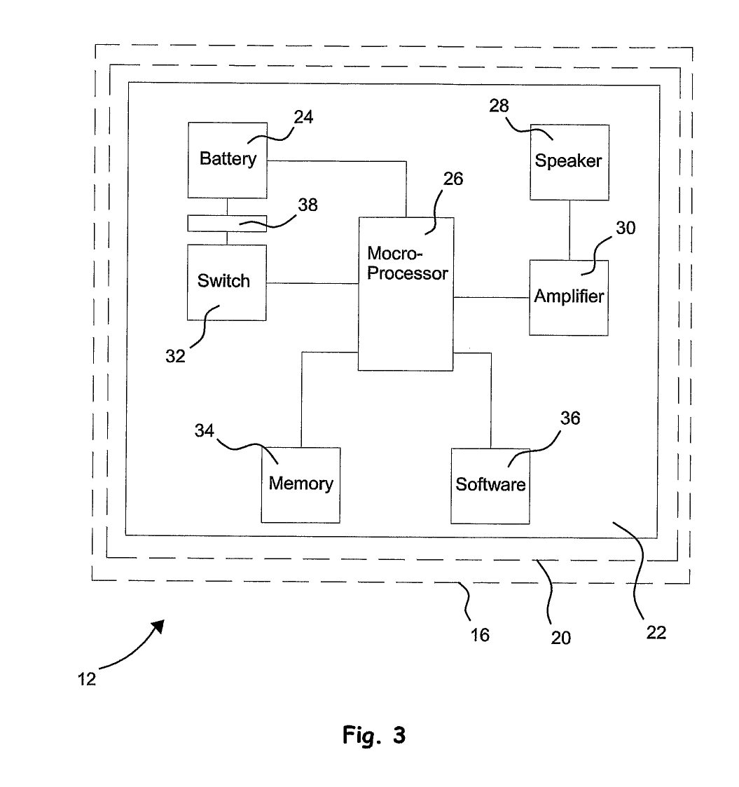

The functionality of the electronic device 18 will now be described with reference to FIG. 3 in which there is shown a diagrammatic representation of the wearable device 12 with a basic block diagram showing the principal components of the electronic device 18. The electronic device 18 comprises a printed circuit board 22 upon which all components are mounted. The device 18 further includes: a power supply 24 in the form of a number of rechargeable batteries; a microprocessor 26, such as a PIC microcontroller, for example a PIC12C805 microcontroller; an output device in the form of a speaker 28 and associated amplifier 30 which is controlled by the microprocessor 26; and a switch 32 adapted to be operated externally of the pocket 16 and waterproof casing 20 to operate the speaker 28 via the microprocessor 26. An audio playback memory device 34, such as a Winbond ISD4002-120, stores audio data to be played back by the speaker 28 when the switch 32 is depressed.

Software, represented generally by block 36, is loaded onto the electronic device 18, wherein the microprocessor 26 is adapted to run said software 36 to control the functionality of the memory device 34 to enable playback of the stored audio file(s) when the processor 26 detects an input by activation of the switch 32. Additionally, the software permits control of the power consumption characteristics of the memory device 34 and audio amplifier 30 in order to maximise the life of the battery unit 24. Furthermore, the software 36, when run by the microprocessor 26, permits control over the quality of the audio output and acts to eliminate or at least minimise distortion of the sound output from the speaker 28.

The electronic device 18 further incorporates a dielectric frangible diaphragm 38 which initially electrically isolates the battery unit 24 from the device 18, wherein upon initial activation of the switch 32, the diaphragm is broken such that the battery unit 24 becomes electrically coupled to the device 18.

The quality of the sound output from the speaker 28 is advantageously significantly enhanced by locating the electronic device 18 within the fabric outer pocket 16 as the fabric functions as an acoustic filter and improves sound dispersion, improving the overall quality of the sound transmitted from the electronic device 18 through the pocket 16. The fabric pocket 16 is adapted to filter random frequencies such as hiss and quantisation noise which may exist as a result of digitisation of the sound data to be transmitted.

Although not shown, the wearable device 12, and indeed the garment 10, may be provided in combination with a charger adapted to recharge the battery unit 24. In a preferred embodiment the charger is an inductance charger permitting the battery unit 24 to be recharged while remaining sealed within the waterproof casing 20 and pocket 16.

A significant benefit of the wearable device 12 is that it is capable of being washed in a conventional manner with the garment 10 to which it is attached, by virtue of the sealed waterproof casing 20. Thus, when the garment 10 is to be washed, the wearable device 12, or at least the electronic device 18, does not need to be removed. Accordingly, the device 12 may be permanently attached to the garment 10, for example by welding techniques such as RF and ultrasonic welding, or by stitching or the like. Alternatively, the pocket 16 may be integrally formed with the garment 10.

The garment 10 may be intended for children, and as such may allow a child wearing the garment 10 to activate the device 18 to hear a piece of music, a song, a short story sequence, or some other audio output. The audio output may be associated with some other feature of the garment. For example, the garment 10 may carry a representation of a cartoon character, and on activation the device may play a song associated with the character. Thus, the audio output may be licensed, providing a source of income for the copyright owner. Accordingly, aspects of the present invention are ideally suited for incorporation in promotional items, and may carry an advertising jingle or catch phrase associated with a certain product or service. Furthermore, aspects of the invention are ideally suited for merchandising in association with television programmes, films, music and the like. The device 12 may be provided pre-programmed, or may be programmed at a point of sale, for example promotional garments being sold in association with a concert tour may be loaded with a selected song at the time of sale, the particular song being selected by the purchaser.

It should be understood that the embodiment described above is merely exemplary of the present invention and that various modifications may be made thereto without departing from the scope of the present invention. For example, numerous types of input and output devices may be utilised in place of, or in combination with, the switch 32 and speaker 28 to provide a wide range of functionalities. For instance, one or more lights may be provided which are activated by the microprocessor in the required manner and which are visible externally of the pocket 16. The output device may comprise a transmitter for transmitting data or signals to a suitable receiver. Also, an input device such as a wireless receiver may be provided such that the electronic device 18 may be wirelessly operated, or alternatively may receive data, such as software or music files or the like via wireless transmission. This would allow a music file downloaded from the internet to be loaded into the device 18 by the user. Alternatively, a user could directly or indirectly record a sound sequence on the device 18. For example, a parent could record a goodnight message, story or prayer on a multifunction mobile telephone, and download the message to a device 18 incorporated in pyjamas or bedding, such that a child can replay the message in bed. Other messages could take the form of any identifying statement, for example “This blazer is the property of John Smith.” A remote device could be utilised activate the device to deliver a selected message, for example “Your supper will be served in five minutes.” Additionally, an output device such as a wireless transmitter may be provided such that the electronic device 18 may wirelessly operate or communicate with an external device or appliance, or alternatively may transmit data wirelessly, for example to a computer, audio or visual equipment or the like. Thus, garments could communicate with one another, alerting one user that another user, for example a friend or family member, was nearby and, for example, delivering an appropriate message to the user. Furthermore, an output actuator, such as a motor or the like may be provided. Advantageously, the electronic device may provide interactive functionalities such that the wearable device may be utilised as an interactive plaything or educational apparatus, for example.

Furthermore, the arrangement of electronic components within the electronic device may be varied. For example, the memory device 34 and/or amplifier 30 may form part of the microprocessor 26. The memory device may be of any suitable type, and in many embodiments may incorporate a flash ROM memory device. This would permit the memory device to be readily programmed and reprogrammed.

1. A garment comprising a sealable pocket and an electronic device sealed within a waterproof casing and located within said sealable pocket, said electronic device comprising a power supply, a programmable device, an output device adapted to be controlled by the programmable device, and an input device adapted to be activated to operate the output device via the programmable device.

2. The garment of claim 1, wherein the electronic device comprises a printed circuit board upon which at least one of the programmable device, power supply, output device and input device is mounted.

3. The garment of claim 1, wherein some or all of the components of the electronic device are mounted on a flexible substrate.

4. The garment of claim 1, wherein features of the electronic device are directly mounted on the garment.

5. The garment of claim 1, wherein features of the electronic device are incorporated into the garment.

6. The garment of claim 1 wherein the programmable device comprises a microprocessor.

7. The garment of claim 1, wherein the input device comprises at least one switch.

8. The garment of claim 1, wherein the input device comprises at least one receiver adapted to receive an input signal.

9. The garment of claim 1, wherein the electronic device further comprises a memory device.

10. The garment of claim 9, wherein the memory device incorporates a flash ROM memory device.

11. The garment of claim 9, wherein the memory device is formed separately from the programmable device.

12. The garment of claim 9, wherein the memory device is adapted to receive data via a memory input.

13. The garment of claim 11, wherein the memory input comprise a hard wire connection.

14. The garment of claim 9, wherein the memory device comprises a wireless receiver device adapted to wirelessly receive data to be stored.

15. The garment of claim 14, wherein the wireless receiver is adapted to receive sound such that real time audio data can be captured and stored by the memory device.

16. The garment of claim 1, wherein the output device comprises a speaker.

17. The garment of claim 1, wherein the output device comprises a light.

18. The garment of claim 1, wherein the output device comprises a transmitter.

19. The garment of claim 1, wherein the output device comprises a motor.

20. The garment of claim 1, wherein the power source comprises at least one rechargeable battery cell.

21. The garment of claim 20, wherein the battery is adapted to be recharged by an inductance type charger.

22. The garment of claim 1, wherein the power source is adapted to be initially insulated from the electronic device, becoming electrically coupled to the electronic device prior to or on initial activation thereof.

23. The garment of claim 1, wherein the electronic device is permanently sealed within the waterproof casing.

24. The garment of claim 1, wherein the electronic device is temporarily sealed within the waterproof casing such that said electronic device may be retrieved without destruction of the casing.

25. The garment of claim 1, wherein the electronic device is sealed within an anti-static membrane.

26. The garment of claim 1, wherein the electronic device is adapted to be programmed by an external device.

27. The garment of claim 1, wherein the electronic device includes software loaded thereon and the programmable device is adapted to run said software to permit control of the functionality of the electronic device.

28. The garment of claim 27, wherein the software permits the programmable device to control the output device in the required manner in accordance with a suitable input signal detected by the input device.

29. The garment of claim 27, wherein the software permits control of the power consumption characteristics of the electronic device in order to maximise the life of the power supply.

30. The garment of claim 1, wherein the sealable pocket comprises a fabric, wherein the electronic device is encased within said fabric.

31. The garment of claim 30, wherein the fabric acts as an acoustic filter.

32. The garment of claim 30, wherein the fabric is adapted to filter random frequencies and quantisation noise.

33. A wearable device adapted to be secured to a garment, said device comprising:
a sealable pocket;
a waterproof casing located within said sealable pocket; and
an electronic device sealed within said waterproof casing, said electronic device comprising a power supply, a programmable device, an output device adapted to be controlled by the programmable device, and an input device adapted to be activated externally of the sealable pocket to operate the output device via the programmable device.

34. The wearable device of claim 33, wherein the outer sealable pocket comprises a fabric, wherein the electronic device is encased within said fabric.

35. A method of manufacturing a garment comprising securing a wearable device according to claim 33 to a garment.

36. A method of manufacturing a garment, said method comprising:
providing an electronic device having a power supply, a programmable device, an output device adapted to be controlled by the programmable device, and an input device adapted to operate the output device via the programmable device;
sealing said electronic device within a waterproof casing;
locating said electronic device and waterproof casing within a sealable pocket; and
securing said pocket to an article of clothing.

37. An audio player comprising:
an outer sealable pocket;
a waterproof casing located within said sealable pocket; and
an electronic circuit sealed within said waterproof casing, said electronic circuit comprising a power supply, a programmable device, a memory device for storing an audio file, a speaker adapted to be controlled by the programmable device, and a switch adapted to be activated externally of the outer sealable pocket.

38. The audio player of claim 37, adapted to be secured to an article of clothing.

39. A method of incorporating an electronic device in a garment, the method comprising:
programming an electronic device such that the device is capable of producing at least one selected output on activation by a user; and
incorporating the device in a garment,
whereby a user may activate the device in the garment to provide said at least one selected output.

40. A method of doing business, said method comprising:
obtaining permission to utilise electronically storable data;
providing an electronic device adapted to store and use said data, and programming said electronic device with said data;
securing said electronic device to a garment.

41. The method of claim 40, wherein the storable data is subject to intellectual property rights, and the method involves obtaining permission from the rights holder.

42. The method of claim 40, comprising supplying at least one electronic device incorporating the storable data to a garment manufacturer for incorporation with at least one garment.
